(19) United States
(12) Patent Application Publication
(10) Pub. No.: US 2008/0240213 A1
(43) Pub. Date: Oct. 2, 2008

(54) Home Network System

(76) Inventors: Koon-Seok Lee, Kyungsangnam-do (KR); Seung-Myun Baek, Kyungsangnam-do (KR)

Correspondence Address: MCKENNA LONG & ALDRIDGE LLP, 1900 K STREET, NW, WASHINGTON, DC, 20006, US

(21) Appl. No.: 11/667,061

(22) PCT Filed: Nov. 5, 2004
(86) PCT No.: PCT/KR04/02863

§ 371 Date: Nov. 28, 2007

(51) Int. Cl. H04B 1/38

(52) U.S. Cl. 375/222

(57) ABSTRACT

The present invention relates to a home system, and more particularly to a home network system that is able to reduce of electric device by application of a modem that is capable of independently processing data. The present invention comprises a first electric device to transmit data including a home code input by the outside to a second electric device through a predetermined network; and a second electric device that comprises a modem by which it is connected to the first electric device through the network, and makes the modem to receive the data, after the initialization of the modem is finished, and read the home code from the data and establish it as its own home code.

### TECHNICAL FIELD

The present invention relates to a home network system, and more particularly to a home network system that is able to reduce loads of electric device by application of a modem that is capable of independently processing data.

### BACKGROUND ART

At the present day, home automation technology for automatically controlling home appliances at each home or remotely has almost reached a commercialization point. At its early step, the home automation was able to separately control each home appliance by using a telephone or infrared rays, but it was not possible to interconnect the home appliances. However, there has been suggested a method for building a network of home appliances by using a communication means, and collectively controlling the network by using a controller.

FIG. 1 is a block diagram illustrating a general home network system as a whole. Referring to FIG. 1, a home network connects various digital home appliances so that a user can always enjoy convenient, safe and economic access to the home appliances regardless of the user's location such as inside or outside the house.

Behind the advent of the home network is the fact that so-called white goods such as refrigerators or washing machines have been progressively digitalized due to development of digital signal processing techniques, and new technology-intensive intelligent home appliances have been realized due to rapid development of technologies relating to home appliance operating system and high speed multimedia communication.

Here, an IT network is a type of network that is built to provide data compatibility between a personal computer and peripheral devices or internet services, and an AV network is another type of network that is built between home appliances processing audio data or video data. In addition, a living network refers to another type of network that is built to simply control home appliances, such as home automation or remote meter reading, and may be comprised of a refrigerator, a washing machine, a microwave oven, an electric lamp, a firedamp alarm, an air conditioner and a telephone.

The home network system includes a master device that is an electric device to control an operation of other home appliances or monitoring a status thereof, and a slave device that is also an electric device having a function to respond to the request of the master device and a function of notifying change of status according to properties of the home appliances or other factors. Here, the electric devices include home appliances for the living network service such as a washing machine and a refrigerator as well as electric devices and electric device for the IT network service and the AV network service.

FIG. 2A and FIG. 2B show embodiments of the home network system according to prior arts.

As shown in the FIG. 2A, home network system comprises a slave device 10 that performs its specific functions; a master device 20 that communicates with the slave device 10 to control or monitor the status thereof; and exterior type modem 30 that is installed on the slave device 10 to enable the slave device 10 to communicate with the master device 20.

More particularly, the slave device 10 communicates with the exterior type modem 30 via signal line 50 and comprises a communication interface 10a to carry out communications.

Preferably, the master device 20 communicates through a given transmission line 60 and is equipped with a modem (not shown) and/or a communication interface (not shown) to carry out communications.

Preferably, the exterior type modem 30 comprises a power line 32 with which external power is applied via plug 31; a power element 33 that converts external power applied via the power line 32 into the direct current power (e.g., 5V); a transmission element 34 that transmits and receives a certain signal via the transmission line 60 to and from the master device 20; and a microcomputer that receives signals from the master device 20 via the transmission element 34 and then transmits it to the slave device 10 via the signal line 50 and receives signals from the slave device 10 to the transmission element 34 and then transmits it to the master device 20.

As shown in the FIG. 2B, a home network system comprises a slave device 11 that performs its specific functions; a master device 20 that communicates with the slave device 11 to control or monitor the status thereof; and interior type modem 40 that is installed inside the slave device 11 to enable the slave device 11 to communicate with the master device 20.

More particularly, equipped with a communication interface 11a, the slave device 11 communicates with the interior type modem 40 via signal line 50 and supplies the direct current power to the interior type modem 40.

Preferably, a master device 20 communicates through a given transmission line and is equipped with a modem (not shown) and/or a communication interface (not shown) for communications.

Preferably, the interior type modem 40 is equipped with a transmission element 41 and a microcomputer 42 that performs identical functions of the transmission element 34 and the microcomputer 35 of the exterior type modem shown in FIG. 2A. However, as a direct current power applicable to the interior type modem is directly supplied from the power element (not shown) inside the slave device 11 via the communication interface 11a, the interior type modem 20 does not require a particular power element.

As the exterior type modem 30, shown in FIG. 2A has a separate power element 33, therefore, a plug 31 and a power line 32 are required to be applied with external power, consequently a plug outlet (not shown) for the plug 31 is needed to be installed in a house. If a number of electric devices have such an exterior type modem 3, a number of plug outlets and additional wiring are required to supply power to those devices.

The interior type modem 40, as shown in FIG. 2B, does not have a additional power element and therefore is directly supplied with the direct current power from the slave device 11 or a master device 20, i.e., from an electric device on or in which a modem 40 is installed, so that electric power of the interior type modem 40 is needed to be considered at the time of designing such electric devices. In addition, it is not possible to install an additional modem inside a manufactured electric device. Moreover, as the interior type modem 40 is already installed inside the electric device by a manufacturer, even though the kind of the transmission line 60 is changed afterwards, for example, such a case that a power line transmission is changed to wireless transmission, additional modem cannot be applied to the electric device.

FIGS. 3A and 3B illustrate flowcharts of data processing methods in modems according to prior arts. FIG. 3A is a flowchart of a data processing method of a modems applied to a dedicated network (e.g., a network such as cable, ADSL, VDSL) that does not require a identification code such as a home code, etc. FIG. 3B is a flowchart of a data processing method in modems applied to a universal network (e.g., power line network, wireless network, etc.) that requires a identification code such as a home code, etc. Here, those modems include a n exterior type modem 30 and an interior type modem 40 which are classified by the type of application of those modems to an electric device.

In the step S31 in FIG. 3A, after power is supplied to a modem, it is determined whether a data to be transmitted via the signal line 50 is received from the electric device (a slave device 10, 11 or master device 20 in or on which a modem is installed to process data according to the data processing method of the present invention)

If it receives data to be transmitted, it proceeds into step S32 and transmits the received data to other electric device (master device 20 or slave device 10, 11 which does not carry out the data processing method) through the transmission line 60. If it did not receive the data it proceeds to step S33.

In step S33, after having received data from other electric device through the transmission line 60, the modem determines whether the received data are normal. Here, the normal data mean that the data have no error occurred during the transmission of the data. If the data are not normal, it proceeds to START or can request for the data again. If the data are normal, it proceeds to step S34 and transmits the received data in tact to electronic device through the signal line 50. In particular, in step S34, the modem transmits the received data without making any change to its form, or without making any change to the contents of the data after changing its form.

According to the data processing method, the modem transmits all the normal data received through a transmission line 60 to the electric devices to have the data processed. Because such a data processing increases the load of data to be processed by the electric device, it is necessary to enhance capability of a microcomputer of electric device at the time of manufacturing in order to handle the load of data, so that cost comes to increase.

In addition, such a modem has a disadvantage that it is supplied with electric power and receives data from outside and continues to transmit them to the electric device even when the electric device connected with the modem is out of order and therefore data processing and communications are not possible.

In step S41 shown in FIG. 3B, after the power is supplied, the modem determines whether a home code is established. If the home code was established, it proceeds to step S44, and, if not, it proceeds to step S42.

In step S42, it determines if the modem receives a home code from the electric device or other electric device. If a home code was received, it proceeds to step S43 and establishes the received home code as its own home code. If it not, it waits until the home code is received.

Step S44-S47 is carried out in the same way of step S31-S34 shown in FIG. 3A.

According to the data processing method of the modem, the modem receives home code from one electric device or the other electric device. A network system using home code is a universal network, and therefore it can be possible to freely communicate with neighbor house where this home network system is installed. In other words it is possibility that the modem would receive another house's the home code established by another user and establishes another house's the home code as its own home code. Such a home code establishment problem may bring about bigger problem relating to use of the electric devices and security of the house. In addition, the problems disclosed in the description about FIG. 3A may also occur at the method in FIG. 3B.

### DISCLOSURE OF THE INVENTION

The object of the present invention is to provide a home network system using a modem having an independent built-in power element that does not require additional wirings or plug outs.

Another object of the present invention is to provide a home network system in which various modems corresponding to the kind of the transmission lines can be connected to the electric device without affecting electric power consumption of the electric device connected to the modem.

Another object of the present invention is to provide a home network system using a modem that processes data by itself without increasing load of data being processed by the electric device.

Another object of the present invention is to provide a home network system in which an authorized user establishes a home code in the home network system having a modem.

Yet another object of the present invention is to provide a home network system in which communications are to be disabled by a modem when a trouble occurred in a product so that it is impossible to communicate.

To achieve the objects of the invention, the present invention comprises a first electric device to transmit data including a home code input by the outside to a second electric device through a predetermined network; and a second electric device that comprises a modem by which it is connected to the first electric device through the network, and makes the modem to receive the data, after the initialization of the modem is finished, and read the home code from the data and establish it as its own home code.

Preferably, the second electric device transmits initialization information to the modem, and the modem saves the initialization information and carry out the initialization.

Preferably, the modem carries out the initialization after electric power is supplied to the modem.

Preferably, the initialization information includes at least one of product information, address information and function information.

Preferably, the modem receives the data through the network only when the present state is a home code establishment state and carries out the home code setting.

Preferably, the second electric device further comprises an input means with which a home code establishment command is input by a user, and converts the present state of the modem to the home code establishment state according to the home code establishment command.

Preferably, the input means is installed independent from the modem, and the electric device transmits the home code establishment command to the modem to convert the present state of the modem.

Preferably, the input means is connected to the modem, and the modem directly receives the home code establishment command from the input means.

An electric device for a home network system according to the present invention comprises a body device that comprises a connection interface that is applied with external power and supplies the power to a modem, and transmits and receives a certain packet to and from the modem, and processes the packet received from the connection interface to carry out its specific functions; and a modem that receives the external power from the body device, and receives a certain signal through a certain transmission line and converts the signal that is related to the body device into a certain packet and transmits it to the body device and receives a certain packet form the body device to convert it to a signal that corresponds to the transmission line and transmits it through the transmission line.

Preferably, a modem for a home network according to the present invention comprises a power element that is applied with external power through a power line and converts it to a certain magnitude of the direct current power; and a transmission element that transmits and receives a certain signal through a certain transmission line, and transmits and receives a certain data to and from a microcomputer through the certain transmission line, and converts the signal and data each other; a microcomputer that saves the information relating to a body device and transmits and receives a certain packet to and from the body device through a certain signal line, and transmits and receives a certain data to and from the transmission element, and converts the packet and the data each other, and converts the data received from the transmission element to the packet according to the information and transmits the packet to the body device or processes the data by itself.

Preferably, an electric device for a home network system according to the present invention comprises a body device that supplies external power to the modem through a power line, and transmits initialization information to the modem through a signal line; and a modem that receives the initialization information and saves it, and then processes a signal transmitted or received through a transmission line according to the initialization information.

Preferably, an electric device for a home network system according to the present invention comprises a body device that supplies external power to a modem through a power line, and transmits initialization information to the modem through a signal line; and a modem that receives the initialization information and saves it, and if the present state of the modem is a state of a home code setting, the modem receives a signal including a home code that is received through the transmission line and reads the home code from the signal and establishes it as its own home code.

### BRIEF DESCRIPTION OF THE DRAWINGS

FIG. 1 is a block diagram of a general home network system.

FIGS. 2A and 2B illustrates embodiments of home network system according to a prior art.

FIGS. 3A and 3B are flowcharts illustrating a data processing method of a modem according to a prior art.

FIGS. 4A and 4B are block diagrams of the first and the second embodiments of a home network system according to the present invention.

FIG. 5 illustrates embodiments of connector of FIGS. 4A and 4B.

FIG. 6 is a flowchart illustrating an operation of a home network system according to the present invention.

FIGS. 7A and 7B illustrates other embodiments of a modem according to the present invention.

FIG. 8 is a flowchart illustrating an operation of a home network system using a modem of the FIGS. 7A and 7B.

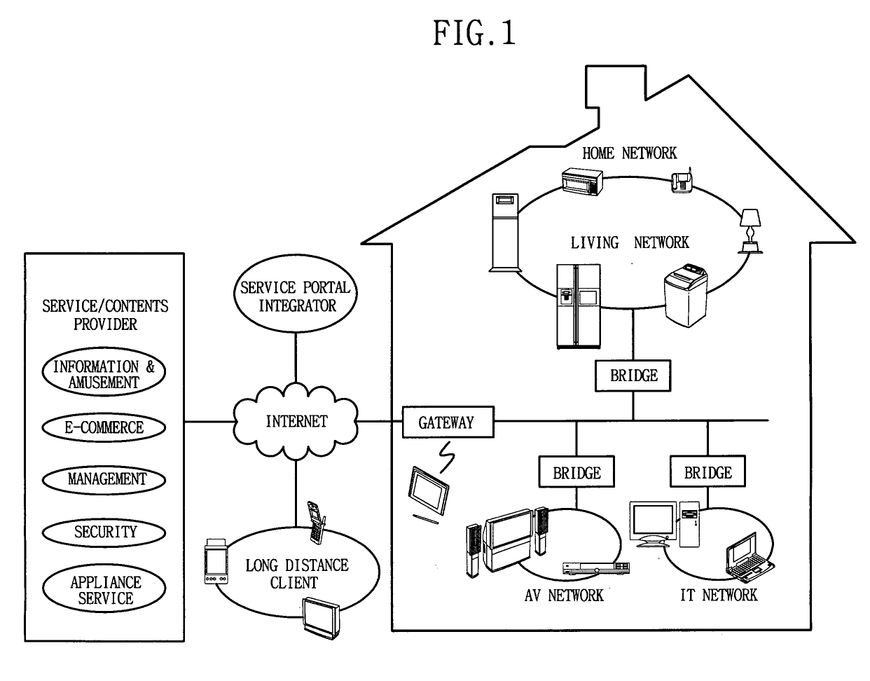

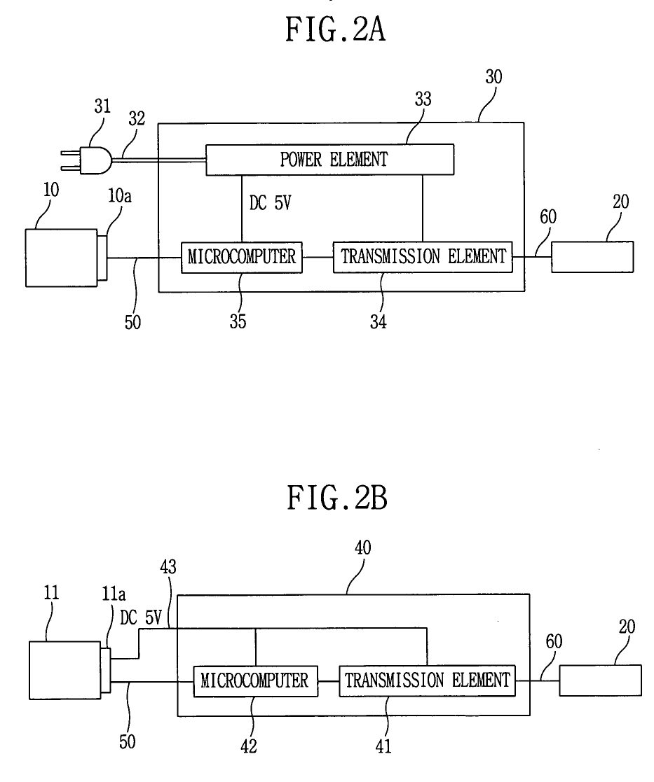

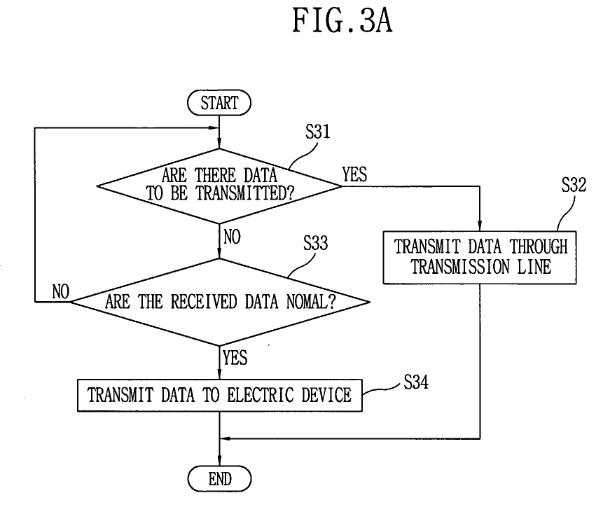

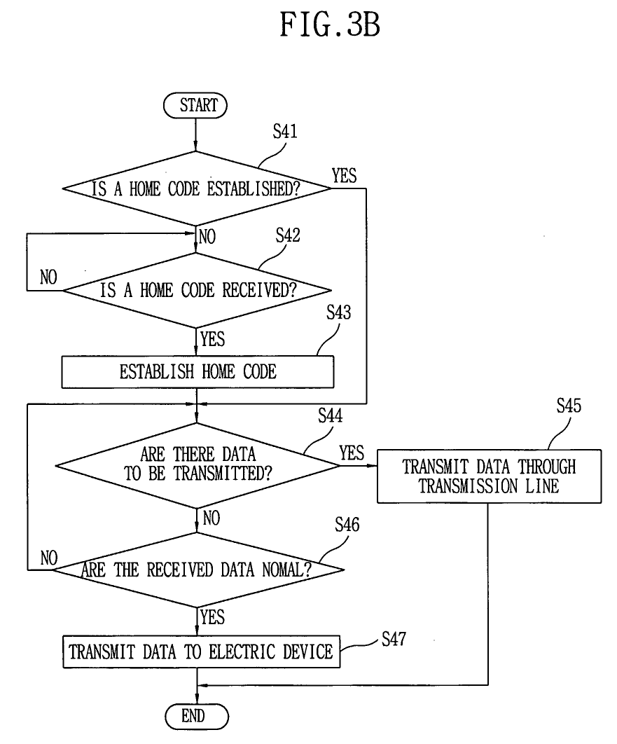

### BEST MODE FOR CARRYING OUT THE INVENTION

The embodiments of the present invention to realize the objects stated above will now be described in detail with reference to the accompanying drawings and figures.

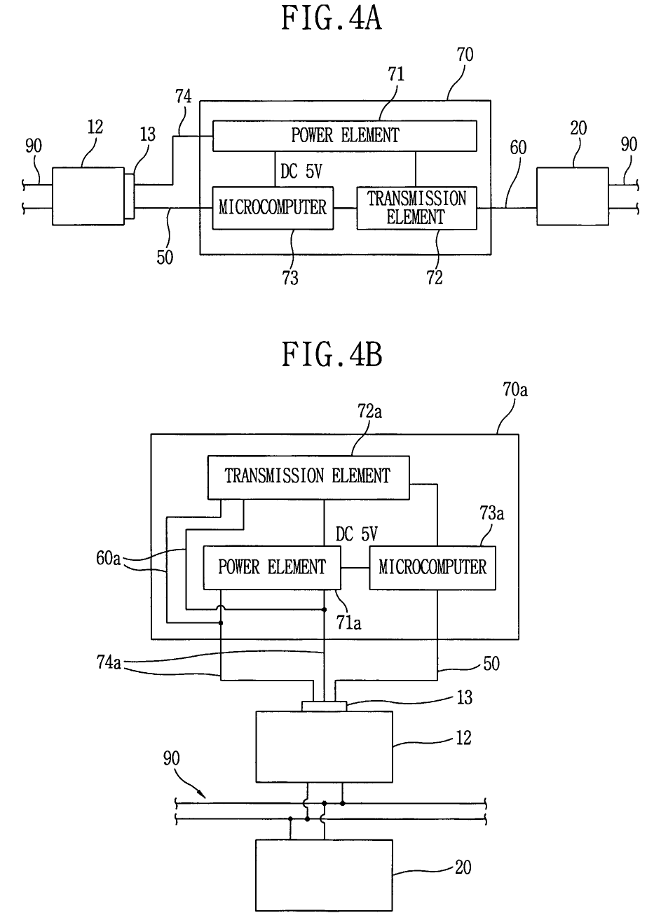

FIGS. 4A and 4B are block diagrams of the first and the second embodiments of a home network system according to the present invention.

Shown in FIG. 4A, a home network system comprises a slave device 12 that carries out its specific function; a master device 20 that communicates with the slave device 12 to control and/or monitor the state thereof; and a modem 70 that is mounted on the slave device 12 and makes the slave device 12 to communicate with the master device 20.

More particularly, the slave device 12 communicates with the modem 70 through a signal line 50 and comprises a communication interface 13 to transmit external power (AC power) without any conversion through a power line 74 of the modem 70. The modem 70 can be installed in or mounted on the slave device 12. In addition, the modem 70 and the slave device 12 are connected each other and carry out their own specific functions, however it should be considered as an integrated electric device. Considering supply of the electric power and accomplishment of those functions being characteristic of the electric device, the slave device 12 becomes a body device and the modem 70 becomes a part. However, considering the processing of signals, they carry out their own specific functions.

Furthermore, the master device 20 communicates through a predetermined transmission line 60 and comprises a modem device (not shown) and/or a communication interface (not shown). The master device 20 is one of the electric device, the modem 70 can be installed in or mounted on the master device 20, however it will be describes mainly focused on the modem 70 installed in or mounted on the slave device 12.

The modem 70 comprises a power element 71 that receives external power (AC power) from the slave device 12 (that is, the body device) through a power line 74 and converts the external power to the direct current electric power (for example, 5V); a transmission element 72 that receives and transmits a certain signal from and to the master device 20 through the transmission line 60 and receives and transmits data from and to a microcomputer 73 and converts the signal and a certain data each other; and a microcomputer 73 that processes the signal received from the master device 20 according to a predetermined data processing method after having received the predetermined data from the transmission element 72, and makes a packet according to the result of processing of the data and transmits it to the slave device 12 through the signal line 50, and convert a packet received from the slave device 12 to data and transmit it to the transmission element 72 to transmit it to the master device 20.

More particularly, the power element 71 is directly applied with AC power of external power from the slave device 12. In other words, the slave device 12 receives the external power with a plug (not shown) through a power line 90 connected to a plug outlet (not shown) installed in a house, the received external electric power is applied to the power element 71 of the modem 70 through the power line 74 without any conversion. In other words the power line 74 is connected to a power line 90 each other, and external power applied from the power line 90 is applied to the power line 74 without any conversion or rectification. In the figure, the power line 74 is illustrated as one line, however it comprises at least two lines. The power element 71 does not require an extra plug for a modem 70, additional wiring and outlets. As the power element 71 of the modem 70 and the power element (not shown) of the slave device 12 are separated, the power consumption of the modem 70 and that of the slave device 12 do not affect each other so that various power consumption for the modem 70 may be designed.

Meanwhile, the transmission element 72 is supplied with the direct current power from the power element 71 and starts its operation and converts the data received from the microcomputer 73 and a signal received from the transmission line 60 (that is, master device 20) each other, that is data format conversion, and provides information appropriately converted according to a receiver. As the kinds of the information formats are different according to the transmission line 60, the transmission element 72 converts the signals and the data according to the kind of the transmission line 60. For example, the format of data to be transmitted between the microcomputer 73 and transmission element 72 is constant, however in case that the transmission line 60 is a cable or wireless, the formats of information to be transmitted are different, consequently the transmission element 72 makes information's appropriate conversion according to the receiver or the kind of the transmission line.

The transmission element 72 comprises an extra circuit (not shown) for the purpose of dividing electric power between the transmission line 60 and the microcomputer 73 and separating the transmission line 60 and the microcomputer 73 physically.

Next, to transmit the data received from the transmission element 72 to the slave device 12, the microcomputer 73 converts the data to the packet in a predetermined format that is readable to the slave device 12. To the contrary, the microcomputer 73 converts the packet transmitted from the slave device 12 to the data format that can be processed in the transmission element 72 and transmits it. The microcomputer 73 converts the packet transmitted through the signal line 50 to the data and processes the data according to MAC (Message Authentication Code) algorithm.

Here, RS-232 protocol can be applied to the signal line 50. The microcomputer 73 comprises a separate receiver-transmitter (not shown) to communicate through the signal line 50, the receiver-transmitter can communicate with microcomputer 73 through UART (Universal Asynchronous Receiver/Transmitter) and communicate with slave device 12 in the RS-232 protocol. Another device can be installed for communication between the microcomputer 73 and the slave device 12.

In addition to conversion between the data and the packet, the microcomputer 73 can read contents of data transmitted from the transmission element 72, and carries out data processing independently of the slave device 12. For the data processing, the microcomputer 73 comprises storage means (not shown) to save certain information, etc. Such a data processing process and a home code processing according to the physical characteristics of transmission lines 60 will be described in detail.

Shown in FIG. 4B, according to another embodiment of a home network system of the present invention, the master device 20 and slave device 12 communicate each other and supply the electric power through the power line 90 and a modem 70a is similar to the modem 70 in FIG. 4A, however its transmission line for the communication with the master device 20 is a power line different from that of FIG. 4A. In other words, the modem 70a uses the power line 60a as transmission line, and therefore its transmission element 72a is connected through the transmission line 74a connected to the slave device 12 and the transmission line 60a. The transmission element 72a further comprises decoupling circuit (not shown) for power line communication.

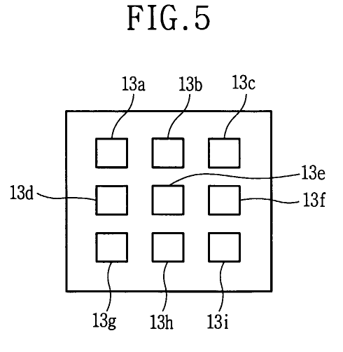

FIG. 5 is an embodiment of a connector of FIGS. 4A and 4B. When the power line 74 and the signal line 50 of FIG. 4A and the power line 74a and the signal line 50 of FIG. 4B are connected to the slave device 12, each end is connected to one connector 13 and then is connected to the slave device 12 (or connection interface installed in the slave device 12, for example, an adaptor) through the connector so that the modem 70 and the slave device 12 are connected each other.

This connector 13 comprises input pins 13a, 13b, 13c for power supply, dummy pins 13d, 13e, 13f for additional use, and pins 13g, 13h, 13i for communication lines to which the end of the signal line 50 is connected. The slave device 12 (or a connector installed in the slave device 12) has a structure corresponding to the connector 13. When a modem 70 is installed inside or outside the slave device 12, the connector 13 makes the connection easily done. The position of installation of the connector and adaptor can be changed each other. In this embodiment, the power line 74 is connected to input pins 13a, 13c (for 2 phase electric power) and the signal line 50 is connected to the pins 13g, 13h, 13i for communication lines.

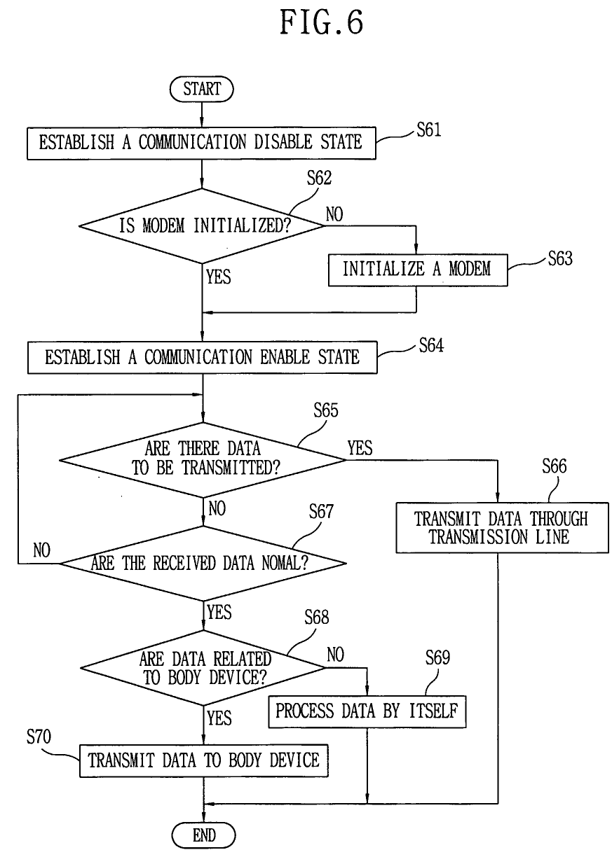

FIG. 6 is a flowchart illustrating an operation of a home network system according to the present invention. An operation shown in the flowchart is applied to any kind of wire and dedicated network as the transmission line 60 shown in FIG. 4 is a cable as ADSL, VDSL etc. In other words, it can be applied to one that does not require an identification code such as a home code.

More particularly, in step S61, when the slave device 12 is applied with external power, the external power is applied to the power element 71 through the connector 13 and the power line 74, then the power element 71 supplies the direct-current power to the transmission element 72 and the microcomputer 73. The microcomputer 73 controls a transmission element 72 to disable communication with other electric device for the time being. The microcomputer 73 can also disable communication with the slave device 12, that is the body device. During communication disable state, it is possible to receive the signal and/or the packet transmitted to a modem 70, however it is not processed but discarded.

In step S62, the microcomputer 73 determines whether the modem initialization process is carried out. The microcomputer 73 determines by figuring out whether information relating to the slave device 12 connected to the connector 13 is saved in a storage installed in the microcomputer 73. The Information relating to the slave device 12 (that is, the body device) includes at least one information among product information (for example, kind, name, and production date of a product, and the version of the software installed), address information (for example, ID number to distinguish each electric device such as 0x01, 0x02, etc.) and function information (for example, in case of a washing machine, information for command such as washing functions, drying functions, etc.). In addition to the information mentioned above, other information can be included in the information relating to the slave device 12 (that is, the body device). If the modem initialization process is carried out, it proceeds to step S64, if it not, it proceeds to step S63.

In step S63, the microcomputer 73 transmits a packet in order to request the modem initialization information to the slave device 12, and in response to the request, the microcomputer 73 receives the packet including information relating to the slave device 12 and saves in its storage means so that the modem initialization process may be carried out. The microcomputer 73 communicates with the slave device 12 by establishing communication with the slave device 12 in an enable state, while communication through the transmission element 72 is still in a disable state. If the slave device 12 cannot transmit the initialization information due to its disorder, other to say, if the microcomputer 73 did not receive the initialization information after a designated time lapses or after the microcomputer 73 had transmitted a packets to request the modem initialization information several times, the microcomputer 73 maintains the communication disable state in step S61.

Consequently, even when the slave device 12 is out of order, it is prevented that a signal received from the mater device 20 is transmitted to the slave device 12. Other to say, the modem 70 does not carry out independent communications.

In step S64, the microcomputer 73 establishes both communications with the slave device 12 through the signal line 50 and through the transmission line 72 in an enable state.

In step S65, after the microcomputer 73 received a predetermined packet from the slave device 12, if it converts the packet into data, that is, if there are the data to be transmitted through the transmission line 60, it proceeds to step S66, if not, it proceeds to step S67.

In step S66, the microcomputer 73 transmits data to the transmission element 72, and then the transmission element 72 converts the data to a signal according to the transmission line 60 and transmits it.

In step S67, after the microcomputer 73 receives data from a transmission element 72, it determines whether the data is normal, prior to convert the data into a packet. The normal data mean that the signal transmitted through the transmission line 60 does not have any transmission error. If the data are normal data, it proceeds to step S68, if not, it requests re-transmission of the data or it proceeds to step S65.

In step S68, the microcomputer 73 determines whether the received date is a date relating to the slave device 12 (that is, the body device). The microcomputer 73 carries out the determination by comparing the received data with the stored data relating to the slave device 12. More particularly, the microcomputer determines whether the received data include information relating to a product itself and/or functions of the product such as function to control and/or to monitor the state of the slave device 12. If so, it proceeds to step S70, if not, it proceeds to step S69.

In step S69, the microcomputer 73 processes data that has no direct relationship to function for controlling and/or monitoring the state of the slave device 12 such as data for management of network (for example, a dummy signal, etc.) by itself.

In step S70, the microcomputer 73 converts the received data to a packet and transmits it to the slave device 12.

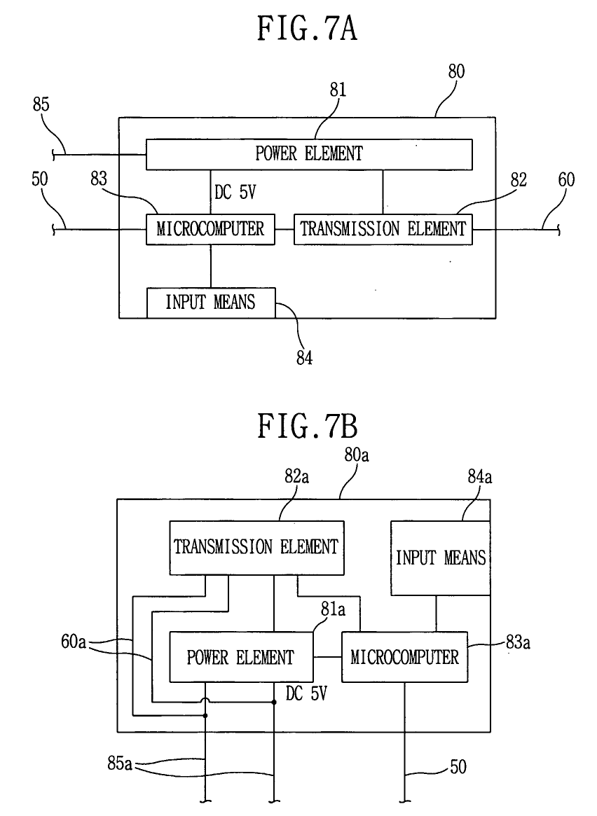

FIGS. 7A and 7B illustrates other embodiments of a modem according to the present invention.

A modem 80 shown in the FIG. 7A is connected to the slave device 12 with a connector (not shown) of a power line 85 and a signal line 80 as shown in FIG. 4A, and connected to the master device 20, an external electric device, through a transmission line 60. The transmission line 60 is wireless network, that is, a universal network, different from a transmission line as shown in FIG. 6. The modem 80 requires an identification code such as a home code due to the characteristic of such a universal network. Such an identification code is input by a user or transmitted from the master device 20 automatically, as described in the paragraph of Background Art.

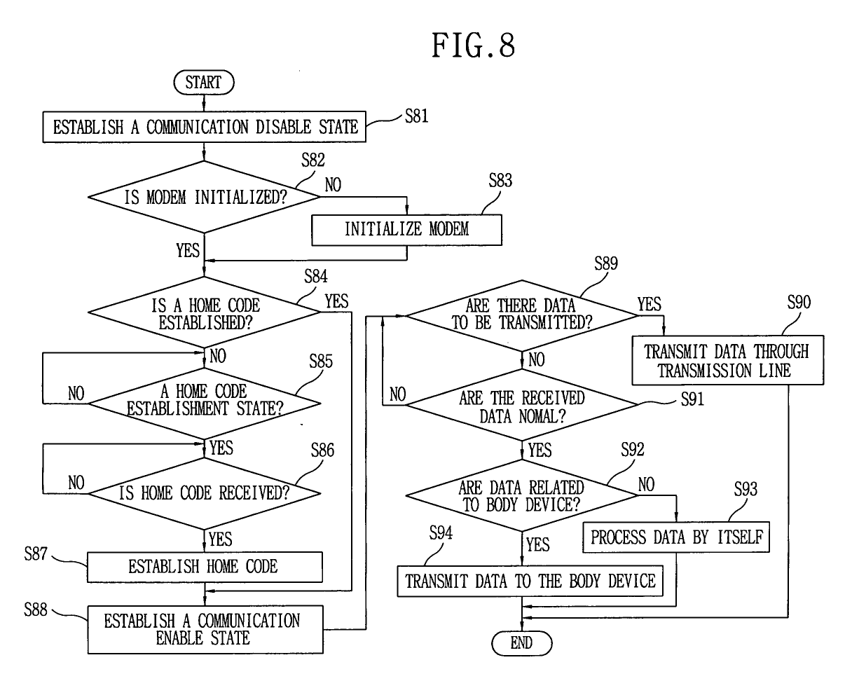

More particularly, the modem 80 comprises a power element 71 and a transmission element 72 of the modem 70 as shown in FIG. 4A, and it can further comprise an input means 84. The input means 84 includes at least two alternatives to select the state of a modem 80, that is, a home code establishment state and a cancellation of the home code establishment state providing such as an on/off switch. The microcomputer 83 establishes or does not establish a home code, according to the state of the input means 84 that will be illustrated in detail in FIG. 8. As shown in FIG. 7A, the slave device 12 can comprise a certain input means (for example, input key, touch pad, etc.) as well as input means 84 directly connected to the modem 80. If a command for a home code establishment state from the input means is input by a user, the slave device 12 generates a packet corresponding to this, and transmits it to the modem 80, next, the microcomputer 83 of the modem 80 can convert the present state to a home code establishment state or cancel the present state according to the command.

A modem 80a shown in FIG. 7B, which transmission line is a power line 60a, a universal network, has the same structure as that of FIG. 4B, and requires an identification signal such as a home code shown in FIG. 7A. The modem 80a further comprises an input means 84a as shown in FIG. 7A, its function is as same as described above.

FIG. 8 is a flowchart to show an operation of the home network system using a modem of FIG. 7.

More particularly, steps S81-S83 of FIG. 8 are carried out in the same way of the steps S61-S63 of FIG. 6.

In step S84, the microcomputer 83 accesses to its storage means and determines whether there is the home code set by the master device 20. If there is not a home code, that is, it is in the state that the home code has not been established, and therefore it proceeds to step S85, and if not, it proceeds to step S88.

In step S85, the microcomputer 80 determines whether the present state is a home code establishment state. This step S85 is carried out, as described above, by determining whether the home code establishment command is input by the input means 84 or is received from the slave device 12. The microcomputer 80 can establish communication with the slave device 12 in an enable state by means of a home code establishment method.

If the present state is a home code establishment state, it proceeds to step S86, and, if not, it waits until it will become a home code setting state. In such a standby state, the microcomputer 83 disables any kind of communication through the transmission line 60.

In step S86, the microcomputer 83 controls the transmission element 82 to receive the signal through a transmission line 60, and when the transmission element 82 converts the signal to data, and it determines whether the data include a home code. If any home code is not included, the microcomputer 83 discards the data that does not include the home code, and waits until it will receive data including a home code. If a home code was included in the data, it proceeds to step S87, and the microcomputer 83 reads the home code from the received data, establishes and saves it as its own home code.

In step S88, the microcomputer 83 established communication with the slave device 12 and communication through the transmission line 60 in an enable state.

The steps S89-S94 are carried out in the same way of the steps S65 of—S70 shown in FIG. 6. But in the step S91, the microcomputer 83 additionally compares the home code included in received data with a home code previously established, if they are identical, it determines it as normal data, and if not, it discards the data.

According to the home code establishment method in steps S85-S87, when an authorized user (in other words, an owner or an installer of a home network system, or the one who installs the system) tries to establish a home code at his option, he can establish it only after he establishes the modem 80 in a home code establishment state. Therefore, if the modem is not in the home code establishment state, even if a signal including the home code set by an external user is received, the modem does not carry out home code establishment according to the received home code. However, during a standby-time for the home code establishment after the authorized user establishes the modem 80 in a home code establishment state in order to carry out the home code establishment, there is a possibility that an external user can carry out a home code establishment, however as the standby-time is short, the chances are very small.

Although the preferred embodiments of the present invention have been described, it is understood that the present invention should not be limited to these preferred embodiments but various changes and modifications can be made within the spirit and scope of the present invention as hereinafter claimed.

What is claimed is:

1. A home network system, comprising:
a first electric device to transmit data including a home code input by the outside to a second electric device through a predetermined network; and
a second electric device that comprises a modem by which it is connected to the first electric device through the network, and makes the modem to receive the data, after the initialization of the modem is finished, and read the home code from the data and establish it as its own home code.

2. A home network system of claim 1, wherein, the second electric device transmits initialization information to the modem, and the modem saves the initialization information and carry out the initialization.

3. A home network system of claim 1 or 2, wherein, the modem carries out the initialization after electric power is supplied to the modem.

4. A home network system of claim 2, wherein, the initialization information includes at least one of product information, address information and function information.

5. A home network system of claim 1, wherein, the modem receives the data through the network only when the present state is a home code establishment state and carries out the home code setting.

6. A home network system of claim 5, wherein, the second electric device further comprises an input means with which a home code establishment command is input by a user, and converts the present state of the modem to the home code establishment state according to the home code establishment command.

7. A home network system of claim 6, wherein, the input means is installed independent from the modem, and the electric device transmits the home code establishment command to the modem to convert the present state of the modem.

8. A home network system of claim 6, wherein, the input means is connected to the modem, and the modem directly receives the home code establishment command from the input means.

9. An electric device for a home network system, comprising:
a body device that comprises a connection interface that is applied with external power and supplies the power to a modem, and transmits and receives a certain packet to and from the modem, and processes the packet received from the connection interface to carry out its specific functions; and
a modem that receives the external power from the body device, and receives a certain signal through a certain transmission line and converts the signal that is related to the body device into a certain packet and transmits it to the body device and receives a certain packet form the body device to convert it to a signal that corresponds to the transmission line and transmits it through the transmission line.

10. An electric device for a home network system of claim 9, wherein, the modem saves the information relating to the body device.

11. An electric device for a home network system of claim 10, wherein, the information includes at least one of product information, address information, and function information of the body device.

12. An electric device for a home network system of claim 10, wherein, the signal relating to the body device is a signal that is related to function for controlling and/or monitoring the body device.

13. An electric device for a home network system of claim 10, wherein, the modem processes the signal that is not related to the body device by itself.

14. A modem for a home network, comprising:
a power element that is applied with external power through a power line and converts it to a certain magnitude of the direct current power; and
a transmission element that transmits and receives a certain signal through a certain transmission line, and transmits and receives a certain data to and from a microcomputer through the certain transmission line, and converts the signal and data each other;
a microcomputer that saves the information relating to a body device and transmits and receives a certain packet to and from the body device through a certain signal line, and transmits and receives a certain data to and from the transmission element, and converts the packet and the data each other, and converts the data received from the transmission element to the packet according to the information and transmits the packet to the body device or processes the data by itself.

15. A modem for a home network of claim 14, wherein, the microcomputer transmits data relating to function for controlling and/or monitoring the body device to the body device.

16. A modem for a home network of claim 14, wherein, the modem comprises the power line and the signal line as an integrated type of connector/adaptor.

17. A modem for a home network of claim 14, wherein, the transmission line is connected to the power line.

18. An electric device for a home network system, comprising:
a body device that supplies external power to the modem through a power line, and transmits initialization information to the modem through a signal line; and
a modem that receives the initialization information and saves it, and then processes a signal transmitted or received through a transmission line according to the initialization information.

19. An electric device for a home network system of claim 18, wherein, after the power is supplied to the modem, the modem does not carry out communications through the transmission line until it saves the initialization information through the transmission line.

20. An electric device for a home network system of claim 18, wherein, the modem transmits the signal relating to function for controlling and/or monitoring the body device to the body device.

21. An electric device for a home network system of claim 18, wherein after the power is supplied to the modem, the modem does not carry out communications through the transmission line until it finishes a home code setting process through the transmission line.

22. An electric device for a home network system of claim 18 or 21, wherein, the electric device further comprises an input means with which a home code establishment command is input by a user, and converts the present state of the modem to a home code establishment state according to the home code establishment command.

23. An electric device for a home network system of claim 22, wherein, if the present state is a home code establishment state, the modem receives a signal including a home code through the transmission line, and reads the home code from the signal and establishes it as its own home code.

24. An electric device for a home network system of claim 22, wherein, the modem receives the signal and then determines whether it includes home code or not, and discards the signal that does not include the home code.

25. An electric device for a home network system of claim 18, the modem comprises the power line and the signal line as an integrated type of connector/adaptor and the modem is connected to the body device through them.

26. An electric device for a home network system of claim 18, wherein, the transmission line is connected to the power line.

27. An electric device for a home network system, comprising:
a body device that supplies external power to a modem through a power line, and transmits initialization information to the modem through a signal line; and
a modem that receives the initialization information and saves it, and if the present state of the modem is a state of a home code setting, the modem receives a signal including a home code that is received through the transmission line and reads the home code from the signal and establishes it as its own home code.

28. An electric device for a home network system of claim 27, wherein after the power is supplied to the modem, the modem does not carry out communications through the transmission line until it finishes a home code setting process through the transmission line.

29. An electric device for a home network system of claim 27 or 28, wherein, the electric device further comprises an input means with which a home code establishment command is input by a user, and converts the present state of the modem to a home code establishment state according to the home code establishment command.

30. An electric device for a home network system of claim 29, wherein, if the present state is a state of home code setting, the modem receives a signal including a home code through the transmission line.

31. An electric device for a home network system of claim 30, wherein, the input means is installed in or on the modem, the modem receives the home code establishment command directly from the input means.

32. An electric device for a home network system of claim 30, wherein, the input means is installed in or on the electric device, the electric device receives the home code establishment command from the input means and transmits it to the modem.

33. An electric device for a home network system of claim 30, wherein the modem comprises the power line and the signal line as an integrated connector and the modem is connected to the body device through them.

34. An electric device for a home network system of claim 30, wherein the transmission line is connected to the power line.
